(19) United States
(12) Patent Application Publication
(10) Pub. No.: US 2026/0288484 A1
(43) Pub. Date: Sep. 24, 2026

(54) INSIGHT-BASED DATA SOURCE MANAGEMENT

(71) Applicant: IPLA Holdings Inc., New York, NY (US)

(72) Inventors: Lu LIU, Conshohocken, PA (US); Dale SEED, Allentown, PA (US); Quang LY, North Wales, PA (US); Catalina MLADIN, Hatboro, PA (US)

(73) Assignee: IPLA Holdings Inc., New York, NY (US)

(21) Appl. No.: 19/472,354

(22) PCT Filed: Apr. 4, 2024
(86) PCT No.: PCT/US2024/023023

§ 371 Date: Oct. 3, 2025

Related U.S. Application Data
(60) Provisional application No. 63/457,597, filed on Apr. 6, 2023.

(51) Int. Cl. G06F 9/445; G06F 9/54

(52) U.S. Cl. CPC G06F 9/44505; G06F 9/541

(57) ABSTRACT

Disclosed herein are methods and systems for the determination or generation of datasets for data-centric services, for example ML services. An apparatus may receive a data source management service request associated with a data source. The apparatus may determine, for each data source of one or more data sources, a data source profile. The apparatus may send, to the data source, a configuration indication. The apparatus may determine, for the data source, at least one of data usage associated with the data source or an indication of data analysis associated with the data source, wherein the indication of the data analysis is received from a computing device. The apparatus may send, to at least one of the data source or the computing device, an updated configuration indication.

### CROSS-REFERENCE TO RELATED APPLICATIONS

This application claims the benefit of U.S. Patent Application No. 63/457,597, Filed on Apr. 6, 2023.

### BACKGROUND

High-quality data is crucial for many data-centric services. For example, in a machine learning (ML) service, collecting data and generating a high-quality training dataset is an important step of building a functional model. To improve the quality of the training data, many of the existing ML services may take the approach of applying data processing methods and techniques to the data that has been collected. Currently, there is a lack of support to configure and optimize the data collection process at the very beginning of the data flow, for example, at the data sources.

### SUMMARY

Systems, methods, and apparatuses are disclosed for implementing insight-based data source management that may provide guidance to data sources in generating data and building datasets for data-centric services, for example ML services. The service may support any number of capabilities. The data source management procedure may describe the interactions between the data source management service, data sources, a data pipeline, and a requestor for the service. Any number of procedures may be implemented to enable dynamic data source management in different scenarios.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 shows an example ML pipeline.

FIG. 2 shows an example data source management service.

FIG. 3A shows an example data instance type.

FIG. 3B shows an example data instance type.

FIG. 4 shows example data source management procedures.

FIG. 5 shows an example method for adding and dropping a feature and/or column of data.

FIG. 6 shows an example method for adjusting a data rate and/or policy.

FIG. 7 shows an example method for activating and/or deactivating a data source.

FIG. 8 shows an example method for enabling and/or disabling local processing at data sources.

FIG. 9 shows an example method for updating configuration with a new or external data source.

FIG. 10 shows an example overview graphical user interface (GUI).

FIG. 11 shows an example data source GUI.

FIG. 12 shows an example data pipeline GUI.

FIG. 13 shows an example management policy GUI.

FIG. 14A shows an example communications system in which the methods and apparatuses described and claimed herein may be an aspect of.

FIG. 14B shows a block diagram of an example apparatus or device configured for wireless communications.

FIG. 14C shows a system diagram of an example radio access network (RAN) and core network.

FIG. 14D shows a system diagram of another example RAN and core network.

FIG. 14E shows a system diagram of another example RAN and core network.

FIG. 14F shows a block diagram of an example computing system.

FIG. 14G shows a block diagram of another example communications system.

### DETAILED DESCRIPTION

As used herein, the following abbreviations and terms may have the following meanings:

| | |
|---|---|
| AI/ML | Artificial Intelligence/Machine Learning |
| API | Application Programming Interface |
| GUI | Graphical User Interface |
| IoT | Internet of Things |
| URI | Uniform Resource Identifier |
| URL | Uniform Resource Locator |
| Data | Entities that will be providing data to build the desired dataset |
| source | with data collection or reporting process. |
| Data | Information of the data regarding its characteristics and quality, |
| insight | such as metadata, feature importance, data balance, variety or |
| | diversity, and the like. |
| Data | A group or sequence of data-centric service entities or data |
| pipeline | functions where the data generated/collected by the data sources |
| | may flow into. |
| Insight | Entities that may provide or generate data insights for the |
| source | data in the data pipeline. |

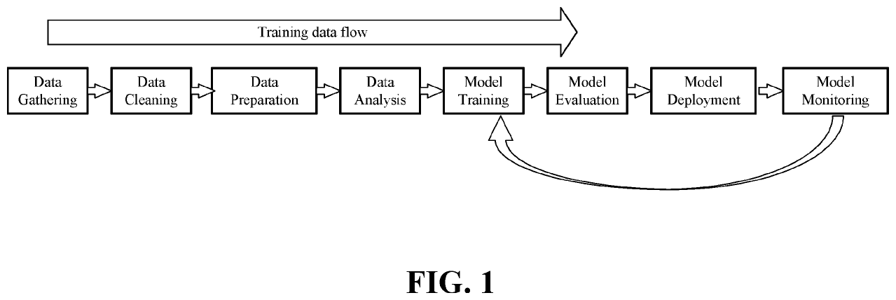

Machine learning (ML) is a branch of artificial intelligence (AI) aiming at building methods that leverage data to improve performance on some set of tasks. ML algorithms build a model based on sample data, i.e., training data, in order to make predictions or decisions without being explicitly programmed to do so. The process of training a ML model may comprise data gathering, data cleaning, data preparation, data analysis, model building/training, model evaluation, model deployment, monitoring and update, and the like. FIG. 1 shows an example ML pipeline and comprises common steps/services.

Training data (set) is crucial for ML services, as the quality of training data directly affects the performance of the trained model. The quality of training data may be reflected by several factors such as:

1) Volume of data, or the size of training dataset. An ML algorithm needs a large enough quantity of meaningful data to train a valid model.

2) Completeness of dataset, whether there are missing values in the training dataset.

3) Duplication and redundancy, whether there are any duplicated data samples (rows) or features (columns) in the dataset.

4) Distribution of data, whether the distributions of data samples are independent and identical, whether the data is distributed evenly across different categories/classes (if any), skewness and kurtosis of data, and the like.

5) Balance or variety of data, whether the data exhibits enough variety and represents different features or categories.

6) Correlation of features/dimensions, whether the features or columns of the data are correlated.

7) Various forms of data issues, such as target leakage (abnormally highly predictive column in the dataset due to unavailability of data), and the like.

Data that is collected for building a training dataset may be represented in a tabular format (or a format that may be mapped to a tabular format), where each row corresponds to a data sample and each column corresponds to a feature (dimension), for example. The tables below show several examples of training data in tabular format.

TABLE 1
Example of training data - customer information

| | | | | Number of | Average |
|---|---|---|---|---|---|
| | | | | shopping | amount of |
| | | | | trips | money spent |
| Username | Gender | Birthdate | Ethnicity | last month | per trip |
| Alice123 | Female | Jun. 1, 1970 | Non- | 5 | $82.55 |
| | | | Hispanic | | |
| Bob_55 | Male | Not | Non- | 2 | $103.90 |
| | | provided | Hispanic | | |
| Lee0301 | Male | Mar. 1, 1980 | Asian | 2 | $50.25 |

TABLE 2
Example of training data - image sensor readings

| | | | System | Oper- |
|---|---|---|---|---|
| Index | Timestamp | Screenshot | Status | ator |
| 1 | 00:00:05 01/10/2022 | (Image data, see Table 3) | Normal | Alice |
| 2 | 00:01:05 01/10/2022 | (Image data, see Table 3) | Normal | Alice |
| 3 | 00:02:05 01/10/2022 | (Image data, see Table 3) | Abnormal | Alice |

An image may be represented by a table with each row specifying a pixel in the image. The value in a column represents the color or brightness codes of the corresponding pixel.

TABLE 3
Example of image data

| Pixel (1, 1) | Pixel (1, 2) | Pixel (1, 3) | . . . | Pixel (640, 480) |
|---|---|---|---|---|
| [128, 0, 0] | [139, 0, 0] | [165, 42, 42] | . . . | [255, 255, 255] |

### Problem Statement

### Use Case #1—Using Customer Questionnaire to Collect Training Data for Shopping Prediction.

A department store would like to use an application powered with ML models to predict a customer's shopping tendencies. To collect data to train the models, a customer survey questionnaire may be designed and posted on the store's website. The questionnaire may ask the customer for their age, gender, ethnicity, products of interest, or the like. Considering the cost of maintaining the collected data and the fact that a customer may be unwilling to fill out a very lengthy questionnaire, it may be desirable for the questionnaire to capture the most important factors with a small number of questions. For example, generally the nationality of a customer may be a less important factor in determining the user's shopping tendencies than other factors. Therefore, the question regarding nationality may not need to be in the questionnaire. However, when it comes to the holiday season, as the exact dates and time range of holiday seasons for different nations and cultures may differ, nationality may become a factor that influences the customer's shopping tendencies more strongly. Therefore, the questionnaire may be redesigned with questions on nationality.

### Use Case #2—Using Sensor Data to Train Image Recognition

An IoT system may want to use ML models for image recognition, which may detect an anomaly in an automated assembly line using video and image data from surveillance cameras. The training dataset may be built by having the cameras record the operational assembly line and associate the recorded images with the status of the assembly line (functioning normally or malfunctioning, for example). While a higher frame rate is preferred, a large volume of image data may quickly overwhelm the storage capacity. Besides, the majority of the captured images likely represent a normally functioning assembly line with repeated scenes. It may be preferable for the camera to use a higher frame rate for capturing assembly line malfunctions and for the camera to use a lower frame rate for capturing normal operations of the assembly line. Therefore, based on changes of the status of the assembly line, the settings of the cameras may need to be updated.

### Potential Issues

Many of the existing ML services assume that the training dataset is already available. There is a lack of guidance on how to build a training dataset (either by collecting raw data or by selecting data from an existing data pool). Also, ML services rely on data preparation services to improve and optimize the training dataset. For example, redundant data samples or columns may be removed during data preparation. However, it would be more effective and efficient to not collect the redundant data during the data collection process as data collection entities (e.g., applications, devices, sensors) usually have limited resources or capacity (in terms of storage or processing power).

From the above use cases it may be seen that configuring and optimizing the data collection process for building the training dataset may change from time to time due to factors such as dynamics in the data characteristics, fluctuations of data requirements, performance of the trained model, and the like. Such information, which may be described as data insights, may be obtained when the data goes through the processing or training procedures. In the existing ML services, there is a lack of support for the data sources to receive feedback or data insights from the data processing and model training processes to adjust the data collection process of the data sources accordingly.

Moreover, the raw data provided by the data sources may go through multiple processing procedures which may change the format or structure of the raw data. Without tracking the link between the original/raw data and the processed data, the data source may not be able to associate the data insights with the data the data source is providing, and the data source may not be able to make adjustments to the data collection process accordingly.

The present disclosure describes an insight-based data source management service that provides guidance to data sources in generating data and building (training) datasets for data centric services (e.g., ML services). The service is capable of, for example:

1) Monitoring the flow of data through the entire data pipeline, tracking how the data is processed and used, identifying the original data source for data at any stage in the pipeline.

2) Gathering data insights from entities in the data pipeline and associating data insights with the corresponding data sources.

3) Adaptively instructing the original data sources to adjust the data collection/selection procedure to optimize the generated dataset.

Particularly, a data source management service may be defined to perform:

1) Receiving a data source management service request for managing data sources to provide data for building a dataset for a data centric service.

2) The request may comprise a list of candidate data sources and the corresponding data source profiles.

3) The request may specify the data pipeline where the data originated from the data sources will be fed into, such as a list of services/entities in the pipeline and how data originated from the data sources will flow through the pipeline.

4) The request may specify if/what data insights may be provided by each of the services/entities in the data pipeline.

5) The request may specify requirements of the data to be provided by the data sources and/or the dataset to be built.

6) Data requirements may comprise required data format, data volume (min or max), data rate (min or max), and the like.

7) Data requirements may comprise required data distribution, required data quality, required data performance, and the like.

8) The request may comprise data source management policies which describe what operations should be performed to the data based on a certain data insight.

9) Maintaining data source profile for each data source in the list of candidate data sources.

A data source may be an application or service (e.g., data generating or collection service, monitoring or logging service, device management service), a data storage such as database or repository, a device (e.g., sensor) or a group of devices.

A data source profile may specify what data may be provided by the data source (e.g., format, features), what configuration may be supported by the data source (e.g., data rate, data reporting schedule, local processing capability).

A data source profile may specify the current configuration and status of the data source (e.g., active, paused, data format, data rate, local processing enabled).

A data source profile may specify the identifiers of data instances (data sets or data streams) that are generated/provided by the data source. Information of multiple data instances generated by the same data source may be managed in a single data source profile or multiple data source profiles.

The list of candidate data sources may be provided by the requestor or identified by the data source management service.

Sending, to one or more data sources, an initial configuration.

The one or more data sources may be selected from the list of data sources based on information in the data source profiles and the data requirements.

The initial configuration may be determined based on information in the data source profiles and the data requirements.

Tracking the usage of data and recording the information in data instance profile.

A data instance profile may record the information of a data set (where data is used/consumed in bulk) or a data stream (where data is used/consumed as the data is generated, sample by sample).

A data instance profile may specify information associated with the data instance comprising: the data format, original data source(s), which entity will be using the data (in the data pipeline), what operations have been applied to the data, data insights associated with the data, preceding and succeeding data instance.

The data source management service may subscribe to the entities in the data pipeline to receive notifications of data whenever the data is used or processed.

Receiving data insights from entities (insight sources) that have used/analyzed the data.

The data insights may indicate the importance of a feature/dimension of the data, the balance or variety of the data, the distribution of the data, and the like.

The data source management service may subscribe to the entities that may provide/generate data insights to receive notifications of data insights whenever data insights are generated.

The data source management service may identify the data source(s) associated with the received data insights, based on the information maintained in the data instance profile.

Sending, to the data sources or the entities managing the data sources, updated configuration information.

Updating a configuration may comprise activating/deactivating one or more data sources, pausing/resuming the data generation/collection process at one or more data sources, discovering or requesting for new/external data sources, switching data sources, adjusting the schedule/frequency of data collection/reporting, modifying the policy of data generation or reporting, adding/dropping a dimension during data generation/collection, enabling/disabling local data processing at data sources, and the like.

The present disclosure proposes an insight-based dynamic data source management service, which provides guidance and supports for collecting data and building a (training) dataset for a data-centric service or application (e.g., building a training dataset for a ML service). The proposed functionality may be implemented as an application/service that is integrated in a data-centric service or as a standalone application/service that may interact with other data-centric services.

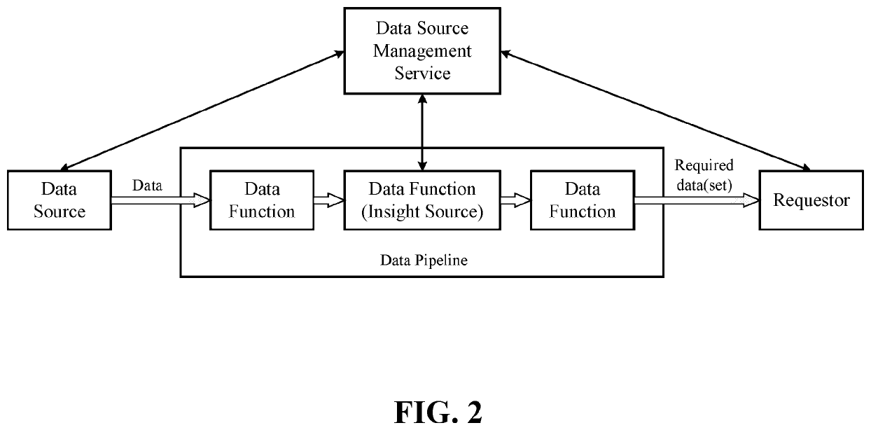

FIG. 2 shows the main entities involved in the data source management service and their interactions.

Data Source: The data sources are the entities that may provide data to build the desired dataset with data collection or reporting process. A data source may be the original data generator such as a data collection or generation service/application (e.g., a device monitoring service, a logging application, a web scraping service/application), or one or a group of devices and/or the corresponding device management service(s). A data source may be a data storage entity such as database or repository. Examples of data sources may comprise:

Cloud monitoring service that collects and tracks metrics, events and metadata of other cloud-based services.

Device management service that may administer and manage devices, while tracking the data collected by the devices or data regarding the devices themselves (e.g., status, performance, and the like).

A database or repository may be viewed as a data source although the database or repository may not be the original source of the data. A database may act as the data source in the scenario where the original data source is not accessible or cannot be configured by the data management service. A database may also act as the data source when the data stored at the database is to be selectively chosen and utilized by a data-centric service or task.

Web scraping or collecting data from websites such as a search engine or other web-based services.

A distributed learning or federated learning participator collecting data locally and using the local data to train the ML model in a distributed or collaborative manner.

Note that for the data in a data storage entity, if the original data source(s) of the data are manageable or configurable by the data source management service, both the original data source(s) and the data storage entity may be viewed as the data source. The data source management service may specify the target data source entity when applying management operations.

Data Pipeline: Data generated or collected by the data sources will flow into one or more data pipelines that consist of data-centric service entities or data functions. The data functions may take the data from data sources or from the output of another data function in the data flow as input, and may perform operations on the data such as merging, processing, modification, analysis, and the like. Data (set) generated at the end/output of the pipeline may be used as data (sets) for ML applications.

Insight Source: The insight sources are the entities in the data pipeline that may provide or generate data insights for the data in the pipeline. An insight source could be a data function in the pipeline, or an entity/function external to the pipeline with access to the data and information from the pipeline. For example, an ML pipeline may consist of data functions that perform analysis of the data to generate data insights, such as a data preparation service, data processing service, labeling service, feature engineering service, and the like. The services may be viewed as insight sources for the data source management service which may be requested to manage data sources for building a training dataset for the ML service. For a ML service/application, data insights provided by the insight sources may comprise:

Metadata: general information and characteristics of the data, such as the dimension of the data (number of rows, columns), features of the data, average/mean value for each feature, distribution of the data, and the like.

Feature importance: a “score” that represents the importance of a feature (e.g., a column of a tabular dataset, a dimension of data). A higher score indicates that the specific feature may have a larger impact on the performance model which is trained with the data. A lower score may indicate that even if the feature is not in the data, the absence of the feature may not greatly affect the performance of the model.

Data labels: Labeled data is typically required for training supervised ML models, where the labels may be present in the raw data or may be obtained with a labeling service/function.

Data balance: For a dataset that is used for training a classification model, if the proportion of minority classes (classes that make up a smaller proportion of the dataset) is much smaller than that of the majority classes (classes that make up a large proportion of the dataset), the dataset may be considered imbalanced.

Data variety or diversity: whether the data is able to represent the full range of cases that the system (model) may have to confront.

Requestor: The requestor is the entity requesting for data source management service. The requestor may be a user that wants to train a ML model and needs a training dataset for the training. The requestor may also be a data function in the pipeline and may be able to generate data insights as an insight source, for example the ML model training service.

Data Source Management Service: The data source management service is the entity that provides the data source management service proposed in the present disclosure. The data source management service would be receiving requests for data source management service, tracking the data flow from data sources to the final destination through the data pipeline, gathering data insights from the insight sources, updating configurations of data sources based on the data insights, providing instructions or feedback to the data sources to optimize the data collection/reporting process such that a desired dataset may be built for the service requestor. The data source management service may perform the following actions to interact with the other entities:

The data source management service receives a request to manage data sources for building a (training) dataset and performs initial configuration on data sources based on the requirements in the request. The requestor may provide a list of candidate data sources to the data source management service. Alternatively, the data source management service may identify a list of data sources based on what data is required by the requestor. The requestor may also specify management policies such as operations to be applied to the data based on different data insights, which may be translated to operations to be applied to the data source configurations by the data source management service.

Once the data sources start generating or collecting data, the data source management service may monitor the data flows and keep track of how the data is used in the data pipeline. The data source management service may record any processing operations that have been applied to the data. The data source management service further gathers data insights from the insight sources.

With the monitoring process and the collected data insights, the data source management service may be able to identify how each data source is contributing to the final dataset and whether/how the configurations of data sources should be updated. Based on the gathered data insights, the data source management service may update the configurations of data sources. The data source management service may send the updated configurations to the data sources or directly apply the changes to the data collection process. Example data source configurations may comprise:

Data format selection: If the data source is able to generate data in different formats, the data source management service may determine which format should be selected.

Activating/deactivating data sources: A data source may be temporarily activated or deactivated based on whether the data source is contributing required/useful data.

Pausing/resuming data collection process: If a data source is conducting a data collection process, the process may be temporarily paused or resumed.

Switching data sources: If the same or similar data may be provided by more than one data source, the data source management service may determine which data source to choose, or the data source management service may dynamically switch between different data sources according to the status of the data sources or other context information.

Adjusting the schedule/frequency of data collection: if the data source supports flexible data collection frequency or schedule, the data source management service may dynamically change the schedule/frequency of the data collection process based on what data rate is required/needed for the pipeline.

Adjust triggering conditions of data collection: For the data collection processes where data is collected/reported based on certain trigger condition (e.g., data will be collected when the value exceeds a certain threshold), the data source management service may configure the condition (threshold) so that the data provided by the data source may match the requirements from the requestor.

Adding/dropping a feature/dimension in data collection: The data source management service may ask a data source to stop or restart collecting a certain feature/dimension of data based on data insights associated with the feature.

Enabling/disabling local data processing at data sources: If the data source is capable of applying local processing before sending the data into the pipeline, the data source management service may configure the data source to enable or disable the processing operations, such as filtering, throttling, up-sampling/down-sampling, and the like.

Correlating data from different sources to ensure integrity of the data when combined together. For example, data from two or more sources may have a common feature such as date or customer ID that the data source management service may use to combine features from the different sources into one dataset.

Changing other (non-data-centric) configurations of the data sources: for example, rotating the camera angle, changing arrangements/locations of sensing devices, and the like.

The above procedure may be performed iteratively to optimize the data collection process and to build the desired dataset.

The following section introduces the information elements that may apply to the main ideas and processes described in the following sections. The defined information elements may be applied in the messages that are exchanged between different entities in the system.

The data source management service may use data source profiles to track and manage the configurations of data sources. A data source profile describes information associated with a data source, for example, what data (format) may be provided by a data source, what configurations may be supported by a data source, current configurations of the data source, and the like. Data source profiles may be provided by the data sources or the service requestor to the data source management service, and the data source profiles may be maintained by the data source management service to enable dynamic configuration. The information elements for a data source profile are shown in Table 4.

TABLE 4
Data Source Profile

| Information Element | Parameter Description |
|---|---|
| Data Source Identifier | Identifier of the data source, may also comprise the IP address/port |
| | number and/or URI of the data source. |
| Supported Data | Descriptions of supported format(s) of data that may be provided |
| Format(s) | by this data source, such as data type, descriptions of the |
| | features/columns/ dimensions of the data (e.g., tag or semantic |
| | descriptions), data schema definitions (e.g., JSON, YAML), and |
| | the like. |
| | May also indicate whether a fixed or flexible data format may be |
| | supported (e.g., whether the data format may be dynamically |
| | changed during the data collection process). |
| Supported | Descriptions of what configurations may be supported by the data |
| Configuration | source for data collection/generation process, such as the supported |
| | schedule and frequency of data generation/reporting, data |
| | collection rate, size of the data instances generated by the data |
| | source, data collection condition (e.g. trigger condition for data |
| | collection/reporting), available local data processing (e.g., |
| | up-/down-sampling, filtering, throttling), storage/caching capability, |
| | and the like. |
| | May also specify other functional capabilities of the data source |
| | that is not specific to data collection/generation process. For |
| | example, if the data source is a video camera that may be placed at |
| | different locations or take pictures at different angles, the |
| | Supported Configuration may specify all the locations or angles |
| | that may be supported by the camera. |
| Data Source | Control and/or indicator of the current status of the data source, |
| Control/Status | such as active, paused, inactive, and the like. |
| Current Data Format | Descriptions of the current data format of the data that is provided |
| | by this data source, such as data type, the |
| | features/columns/dimensions of the data, and the like. |
| Current Configuration | Descriptions of the current configuration of the data source, such as |
| | the current data generation/reporting frequency, data collection |
| | schedule, data collection rate, data collection trigger conditions |
| | (e.g. if a reading exceeds a specific threshold, the data should be |
| | collected/recorded by the data source), local data processing that |
| | have been enabled such as filtering, throttling, up-sampling/down- |
| | sampling, and the like. |
| Associated Data | Identifiers of data instances that are provided by this data source, |
| Instances | which may comprise both the data instances that are currently |
| | being provided by this data source and the data instances that are |
| | provided previously by this data source. |
| Managing Entity | Identifier and/or address of the entity that is managing the data |
| | source (other than the data source management service), with |
| | which the data source management service could interact to apply |
| | the configurations and management operations. |
| Associated Storage | Identifier and/or address (IP address and port number, URI) of the |
| | storage entity which stores or caches the data instances provided by |
| | this data source. |
| Context Information | Context information of the data source which is not reflected in the |
| | Supported/Current Configuration but may be used by the data |
| | source management service in determining the proper |
| | configuration, such as the schedule or availability information, |
| | operational cost, stability, geographical location, and the like. |
| Management Operation | Information of the management operations that have been applied |
| Record | to this data source by the data source management service, such as |
| | what operations have been applied, timestamps of when the |
| | operations are applied, and the like. This may be used for |
| | repeated/iterative operations or rolling-back an action. |
| | The record may be maintained as a per-data source basis or per- |
| | pipeline basis. When the record is maintained as a per-pipeline |
| | basis, the data source management service may specify which data |
| | sources a management operation has been applied to. |

The data source management service may use data instance profiles to track the data provided by the data sources and record information associated with the data.

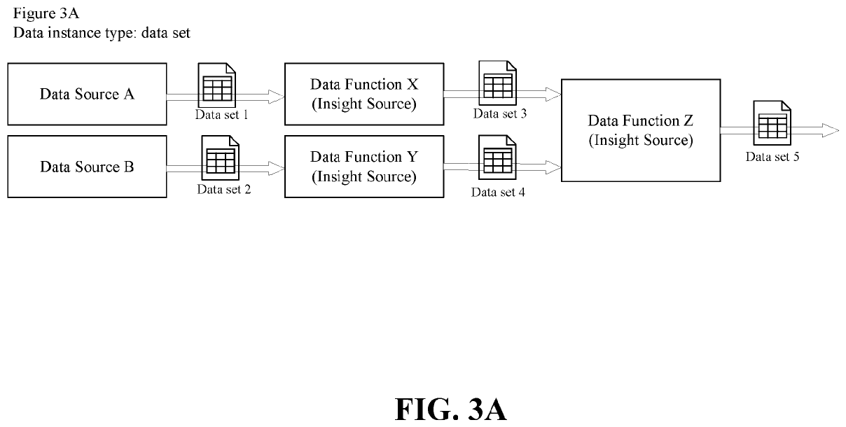

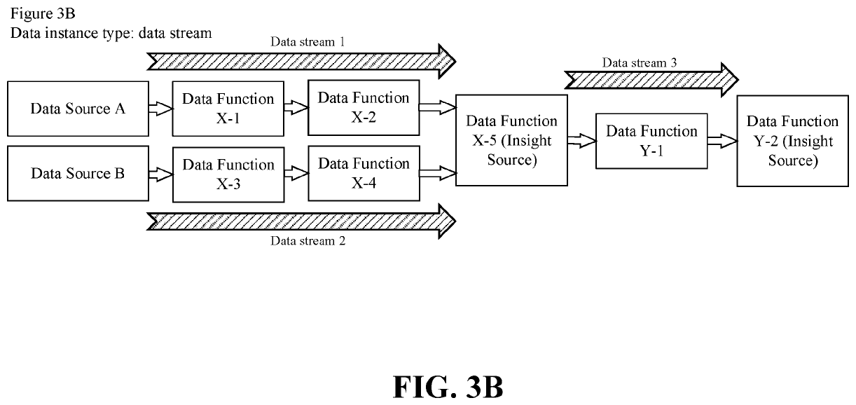

A data instance may be a data set or a data stream, depending on how the data provided by the data sources is consumed by the data functions in the pipeline. The data could be consumed in bulk as data sets, or consumed in a data stream where data samples are consumed one by one as they are being generated. FIGS. 3A and 3B illustrate examples of two types of data instances.

In the scenario where the data instance type is data set, a data function may take one or more data sets as input and generate another data set as output. A data set may be the output of a data source or a data function, and may be the input of a data function. The data set at the output end of the pipeline could be the data set required by the requestor.

In the scenario where the data instance type is data stream, a data function may take one or more data streams as input and generate another data stream as output. A data stream may span across multiple service entities. Each data stream originates from a data source or data function, and ends at a data function. Data in a data stream may be pooled/accumulated at the end of the stream to form a data set.

The information elements for data instance profile are shown in Table 5.

TABLE 5
Data Instance Profile

| Information Element | Parameter Description |
|---|---|
| Data Instance | Identifier of the data instance. |
| Identifier | |
| Instance Type | Specifying the data instance type, i.e., data set or data stream. |
| Data Format | Descriptions of the format of this data instance, such as data type, |
| | features or dimensions of the data, and the like. |
| Data Descriptions | Describes information of the data such as the category/topic of the |
| | data and what the data may be used for, such as finance, |
| | meteorology, industrial, environmental, and the like. |
| Data Sources | Identifiers of the data source(s) where the data instance originated. |
| | A data instance may be associated with more than one data sources. |
| | For example, if the data instance is the result of merging/combining |
| | multiple data instances, the corresponding data source for each |
| | component data instance will be in this parameter. |
| Associated | Information (identifier) of the requestor who requests for the data or |
| Request(or) | the identifier of the data management service request. A data instance |
| | may be associated with more than one requestor or request. |
| Associated Pipeline | Information (identifier) of the data pipeline where the data instance is |
| | fed into and/or present in. A data instance may be associated with |
| | more than one pipeline. |
| Preceding Entity | Identifier and/or address of the (immediate) preceding entity (data |
| | function) where the data instance is generated. The preceding entity |
| | could be a data source or an entity in the data pipeline (which could |
| | be an insight source). |
| | For example, in FIG. 3, the preceding entity of Data set 1 is Data |
| | Source A, the preceding entity of Data stream 3 is Data Function X- |
| | 5. |
| Succeeding Entity | Identifier and/or address of the (immediate) succeeding entity (data |
| | function) where the data instance is being sent. The succeeding entity |
| | could be an entity in the data pipeline (which could be an insight |
| | source). |
| | For example, in FIG. 3, the succeeding entity of Data set 1 is Data |
| | Function X, the succeeding entity of Data stream 3 is Data Function |
| | Y-2. |
| Intra-Stream Entity | (Only applies to data stream.) |
| | Identifiers and/or addresses of the entities (data functions) that lie |
| | within the data stream. |
| | For example, in FIG. 3, Data stream 1 is associated with two intra- |
| | stream entities: Data Function X-1 and X-2. |
| Data Operations | Descriptions of data operations that have been applied to the data |
| | instance by the preceding entity and intra-stream entity (if any). |
| | For example, in FIG. 3, data operations applied by Data Function X |
| | will be recorded in the data instance profile of Data set 3; data |
| | operations applied by Data Function X-1 and X-2 will be recorded in |
| | the data instance profile of Data stream 1, while the profile of Data |
| | stream 3 will record the operations from Data Function X-5 and Y-1. |
| Data Insights | Data insights associated with the data instance. Data insights are |
| | provided by or retrieved from the insight sources among the |
| | preceding entity and intra-stream entities or an external entity. |
| | If data insights are stored at a separate location, the information |
| | element may specify the address of the location. |
| Preceding Data | Identifier and/or address (of the corresponding storage entity) of the |
| Instance | preceding data instance. |
| | For example, in FIG. 3, Data set 1 is the preceding data instance of |
| | Data set 3, Data stream 1 and Data stream 2 are the preceding data |
| | instances of Data stream 3. |
| Succeeding Data | Identifier and/or address (of the corresponding storage entity) of the |
| Instance | succeeding data instance. |
| | For example, in FIG. 3, Data set 5 is the succeeding data instance |
| | of Data set 3, Data stream 3 is the succeeding data instance of Data |
| | stream 1 and 2. |
| Valid Period | The valid time period of the data instance (starting and ending |
| | timestamps). |

The requestor may request for data source management service by sending a request to the data source management service. The request may specify the following information, as in Table 6.

TABLE 6
Data source management service request

| Information Element | Parameter Description |
|---|---|
| Requestor Identifier | Identifier of the requestor. |
| Request identifier | Identifier of the request. |
| Data Source Identifiers | A list of identifiers of candidate data sources that may provide data |
| | required by the requestor, may also comprise the IP address and |
| | port number and/or URI of each data source. |
| | If this parameter is not provided in the request, the data source |
| | management service may identify the candidate data sources based |
| | on the other information provided in the request. |
| Data Source Profiles | Data source profiles of the candidate data sources, or the location |
| | from where the data source profiles may be obtained. |
| | Note that the data source profiles provided in the request may be |
| | incomplete. For example, the requestor may not specify the |
| | Supported Configuration of data sources in the request. In this case, |
| | the data source management service may further contact the data |
| | sources to obtain more information and complement the profiles. |
| | If data source profiles are not provided in the request, the data |
| | source management service may identify the location of the data |
| | source profiles and/or obtain the profiles. |
| Pipeline Information | Identifier and other information of the data pipeline which will be |
| | consuming data from the data sources as required by the requestor. |
| | The information may comprise the sequence or topology of data |
| | functions in the pipeline and the identifiers/addresses of the data |
| | functions. |
| | The description may further comprise information on capabilities |
| | of the data functions in the pipeline, such as what data operations |
| | will be applied to the data by the data function, what data insights |
| | may be generated by the data function. If the information is not |
| | provided, the data source management service may contact each of |
| | the data functions in the pipeline to obtain capability information of |
| | the entities. |
| Pipeline Management | An indicator of whether the data source management service is |
| Authorization | allowed to modify the pipeline and what actions are allowed, such |
| | as adding or removing a data function from the pipeline, modifying |
| | the data flow in the pipeline, and the like. |
| Insight Source | Specifying which data functions in the data pipeline are capable of |
| Information | generating data insights (as insight sources) and what data insight |
| | may be generated by the service entities. May also specify |
| | information of insight sources that are outside the pipeline, if any. |
| | If insight source information is not provided in the request, the data |
| | source management service may identify which entity may act as |
| | insight source and provide data insight by contacting each of the |
| | data functions in the pipeline or contacting an external entity that is |
| | accessible. |
| Data Requirements | Specifying the requirements or preferences of the data to be |
| | generated at the end/output of the pipeline, such as required data |
| | format, data volume (maximum or minimum volume), required |
| | data rate (or range of data rate), required data distribution, required |
| | data quality (e.g. in terms of ratio of missing data, balance, bias, |
| | variety, and the like), data performance (performance of data- |
| | centric services in the pipeline, such as the performance of a ML |
| | model trained with the data), and the like. |
| | In addition, requirements or preferences of the pipeline could also |
| | be specified, such as uniform data format across different data |
| | sources, synchronization or alignment of data from different data |
| | sources, and the like. |
| Initial Configuration | Specifying the initial configuration of the data sources. If this is not |
| | provided by the requestor, the data source management service may |
| | determine the initial configuration. |
| Management Policy | Specifying the data source management policies such as what |
| | operations should be performed on the data or data source based on |
| | a certain data insight. |
| | Examples of management policy: |
| | If the importance of a feature is less than 10% of the |
| | average importance, drop this feature. |
| | If the proportion of a class/category is less than 20% of the |
| | entire dataset, increase the number of data samples from |
| | this class/category and decrease the number of data samples |
| | from the other classes/categories. |
| | If the proportion of a class/category is more than 90% of the |
| | entire dataset, pause the data collection of this |
| | class/category until the proportion drops below 80%. |
| | If the accuracy/precision of the trained model is higher than |
| | 98%, terminate the data collection, otherwise continue |
| | collecting training data until the number of data samples |
| | reaches one million. (This may also be specified in the Data |
| | Requirements.) |
| | If for a certain policy, there are multiple management operations |
| | available that may be applied to the data source to achieve the same |
| | goal, the requestor may specify one or more preferred operations, |
| | or provide an ordered list of preferrable operations, or leave the |
| | decision to the data source management service. |
| | If management policy is not provided by the requestor, the data |
| | source management service may apply default policies. |
| | Alternatively, the data source management service may determine |
| | possible policy choices based on the capabilities of insight sources |
| | (Insight Source Information) and data sources (Supported |
| | Configuration) and ask the requestor to choose from the possible |
| | policies. |
| Data Instance Type | Specifying the preferred data instance type, i.e., data set or data |
| | stream. |
| | If preferred data instance type is not specified in the request, the |
| | data source management service may determine the data instance |
| | type based on other information in the request (properties of the |
| | pipeline or data sources). |
| Authorization Token | Providing an authorization token to the data source management |
| | service so that the data source management service will be |
| | authorized to manage the data sources and obtain information from |
| | the insight sources. |

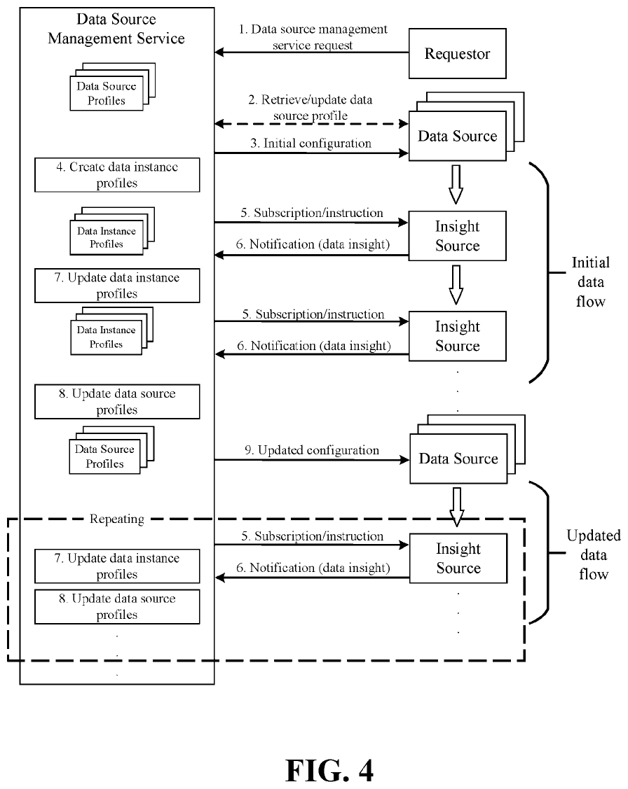

The main steps of data source management procedures are shown in FIG. 4.

Step 1: The requestor sends a data source management service request to the data source management service. In the request, the requestor may specify the information as described in Table 6. The data source management service may send a response to the requestor comprising its identifier, which may be distributed to the data sources and entities in the data pipeline by the requestor for authorization purposes. It is assumed that the requestor and the data/insight sources have a pre-established trust relationship, while the data source management service may not have access to the data sources or insight sources initially. The requestor may grant access to the data/insight sources by notifying the data/insight sources with the data source management service's identifier, or comprising an Authorization Token in the request.

Step 2: If the requestor has not provided Data Source Identifiers in the request, the data source management service may identify the candidate data sources based on other information provided in the request. If the requestor provides a list of candidate data sources but does not provide the corresponding data source profiles or the provided data source profiles are incomplete, the data source management service may retrieve or update the profiles from the data sources or other relevant entities that store/maintain the profiles.

Step 3: Based on the service request and the data source profiles, the data source management service may determine the initial selection and configuration of the data sources. The data source management service may update the Current Configuration parameter in the data source profiles with the initial configuration and configure the data sources accordingly. The data source management service may directly access the data sources or access the corresponding managing entities of the data sources to apply the initial configurations.

The initial configuration may be applied by directly sending a request to the data source to configure its settings of data collection, or sending the data source profile with the initial configurations to the data source, or sending a request to update the data source profile at the data source.

If the initial configuration has not been provided by the requestor, the data source management service may determine the configuration based on data collection experience or a pre-defined default setting. For example, the data source management service may choose to maximize the amount of data that may be collected from the data sources in the initial configuration, in which case the data source management service may activate data collection at all available data sources, set the maximum supported data rate, and the like.

Step 4: The data source management service may create data instance profiles based on the initial configuration and the pipeline information. The data source management service may specify the “Data Sources,” “Preceding/Succeeding Entity” and “Preceding/Succeeding Data Instance” in the data instance profile based on the Pipeline Information provided by the requestor. For the data instances whose preceding entity is the data source, the “Data Format” may be specified as the “Current Data Format” in the corresponding data source profile.

Note that the data provided by a certain data source may be used by more than one data pipeline or requested by more than one request (or). The data source management service may create separate data instance profiles for each request (or)/pipeline, or use a single data instance profile to monitor the data if the requestors/pipelines share the same requirements on the data.

Step 5: The data source management service may request data insights from an insight source, where the request may comprise the identifier of the data source management service, the requestor (of the data source management service) and/or the data pipeline. The data source management service may identify the insight sources based on the Insight Source Information and Pipeline Information from the request and/or identify the insight sources for each insight indicated in the Management Policy. The data source management service may subscribe to the insight sources to receive information of the data and associate the information with the corresponding data instance. Alternatively, the data source management service may instruct a capable entity in the data pipeline to generate the required data insights.

If information of insight sources is not provided in the request by the requestor, the data source management service may identify the required data functions based on the Management Policy. For example, if the Management Policy requires information on the importance of a feature, the data source management service may check if any of the existing data functions in the pipeline is capable of evaluating feature importance. If a capable data function is found, the data function will be used as insight source. If no data function is found, the data source management service may search for an external data function with such capability (and add/insert the data function to the pipeline).

The data source management service may also request other information that may affect the data source configuration from an insight source or a data function in the pipeline, such as the data processing speed at a data function, the data flow rate in the pipeline, and the like.

Step 6: The requested data insights may be sent to the data source management service by the insight sources. The insight sources may send the data insights to the data source management service directly, or store the data insights at a storage service and share the location of the stored data insights with the data source management service.

Step 7: Based on the received data insights, the data source management service updates the Data Insights parameter in the corresponding data instance profiles. If information on what data operations are applied to the data instances has not been provided in Pipeline Information, the data source management service may retrieve related information from the service entities (insight sources) in the pipeline and update the data instance profile with the obtained information.

Step 8: After collecting data insights from the insight sources in the data pipeline, the data source management service may examine the Management Policy in the service request to see if any management operation should be applied. If so, the data source management service may identify the corresponding data sources based on the data source profile and data instance profile. For example, if the management policy indicates a feature of data should be dropped, the data source management service may identify which data source(s) are contributing this feature based on information of the Data Sources or Preceding Entity/Preceding Data Instance indicated in the Data Instance Profile. Essentially, the data source management service “translates” the data insights or data operations defined in the Management Policy to data source configurations by associating data insights and instances in the pipeline with the corresponding data sources.

If Management Policy is not provided in the initial request, the data source management service may offer possible choices to the requestor according to the capabilities of insight sources (i.e., what data insights may be generated/provided) and the Supported Format/Configuration of data sources. For example, one of the insight sources is capable of evaluating the importance of a feature, while the data sources support changing the data format to add or drop a feature of data. Based on this information, the data source management service may recommend management policies such as “If the importance of a feature is less than a threshold, drop this feature” to the requestor.

After identifying the data sources and the corresponding operations, the data source management service may update the configuration of the data sources (data source profiles) accordingly. The data source management service may check the supported format and supported configuration in the data source profile to see if the updated configuration may be supported by the data source. The configuration may be updated by directly sending a request to the data source to change its settings of data collection, or sending the updated data source profile to the data source, or sending a request to update the data source profile at the data source. Example procedures of different types of data source management operations are detailed in Dynamic Data Source Management Options. The data source profiles may be updated before or after the data source management service applies the updated configurations to the data sources (step 9).

The data source management service may also adjust non-data-centric configurations of a data source based on the received data insights. For example, multiple video cameras are deployed as data sources to collect image data. The data source management service may receive data insights indicating the currently collected image data lacks variety (due to all cameras facing the same direction). It is indicated in the Supported Configuration in the data source profiles that the cameras support pan-tilt-zoom functions. The data source management service may determine to send a request to the cameras or the corresponding device management service to rotate the camera to get image data from different angles.

The data source configuration (profile) may be updated after the data has passed through the entire data pipeline (i.e., data source management service has received data insight from all the insight sources in the pipeline), or updated after any data insight is received by the data source management service.

Step 9: The data source management service may instruct the data sources to update their configurations. The data source management service may directly access the data sources or contact the corresponding managing entities of the data sources to apply the updated configurations. The applied operations may be recorded in Management Operation Record.

Steps 5 to 8 may be performed iteratively according to the dynamics in the data insights. The next section Dynamic Data Source Configuration Options shows examples of dynamic configurations of data sources.

The data source profile may also be updated by the data source itself or by the requestor (e.g., when the capability of a data source changes) by sending a request to the data source management service. In this case, the data source management service may update the configurations of the data source and other related data sources accordingly.

In the above procedure, the data source management service is not handling the data flow directly, but the data source management service may influence what data is being sent into the pipeline and what data is generated at the end of the pipeline (and to the requestor) without modifying the data by itself. Alternatively, the data source management service may participate in the data pipeline as an intermediate data function by directly handling the data flow (e.g., retrieving or selecting data instances from data sources, receiving/sending data instances from/to data functions, directing or forwarding the data from one data function to the next).

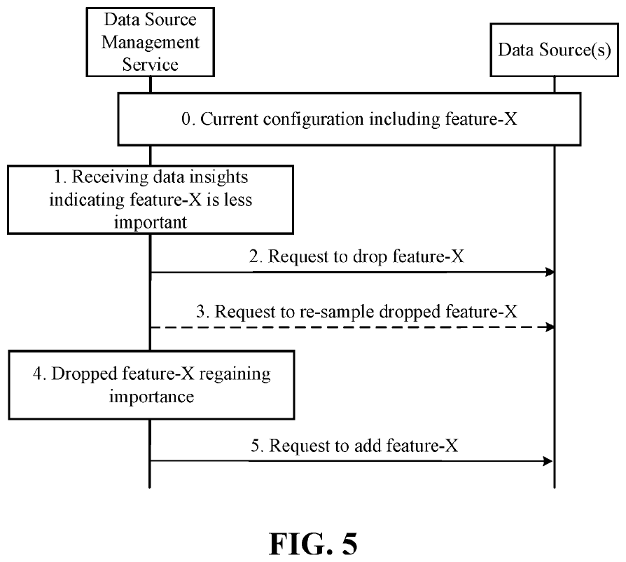

Systems and methods are proposed herein for insight-based data source management. For example, the method described in FIG. 4 generally, and the examples described in FIGS. 5-9 may comprise receiving a first request to configure a data source of a plurality of data sources, wherein the first request comprises one or more policies for configuring the data source to generate data. The method may further comprise determining, based on at least one of the one or more policies, a first configuration associated with the data source. The method may further comprise sending, to the data source, the first configuration. The method may further comprise receiving, from a second service entity, an indication of data analysis associated with data generated by the data source. The method may further comprise determining, based at least in part on the indication of the data analysis and at least one of the one or more policies, a second configuration associated with the data source. The method may further comprise sending, to the data source, the second configuration.

The method described in FIG. 4 may further comprise wherein at least one of the one or more policies comprises: an indication for the data source to generate data, an indication for the data source to stop generating data, an indication for the data source to generate a particular data feature, an indication of a data generation schedule, an indication of a rate of data generation, an indication of a volume of data generation, an indication of a condition to trigger data generation, or an indication for the data source to conduct a processing operation on generated data.

The method described in FIG. 4 may further comprise wherein the data analysis comprises at least one of: determining an importance associated with at least a portion of the data generated by the data source, determining a distribution of the data generated by the data source, or determining metadata associated with the data generated by the data source.

The method described in FIG. 4 may further comprise a plurality of data source profiles, wherein each one of the plurality of data source profiles comprises information associated with a list of one or more configurations supported by each one of the plurality of data sources.

The method described in FIG. 4 may further comprise storing an indication of at least one of: a list of entities the data generated by the data source interacts with or a list of operations applied to the data generated by the data source.

The method described in FIG. 4 may further comprise wherein the data generated by the data source comprises at least a portion of a training dataset for a machine learning model.

The method described in FIG. 4 may further comprise wherein the second service entity comprises at least one of a data preparation service, a data processing service, a machine learning service, a model training service, or a feature engineering service.

The method described in FIG. 4 may further comprise wherein at least one of the first service entity or the second service entity is provided as a middleware service

The method described in FIG. 4 may further comprise wherein the middleware service is a service layer located on top of network protocol stacks.

The method described in FIG. 4 may further comprise wherein the service layer is defined according to a telecommunications standard.

For example, the system described in FIG. 4 may comprise an apparatus comprising a processor and a memory, the apparatus further comprising computer-executable instructions stored in the memory of the apparatus which, when executed by the processor of the apparatus, cause the apparatus to perform, at a first service supporting service capabilities through a set of application programming interfaces (APIs) in a network, operations. The operations may comprise receiving a first request to configure a data source of a plurality of data sources, wherein the first request comprises one or more policies for configuring the data source to generate data. The operations may further comprise determining, based on at least one of the one or more policies a first configuration associated with the data source. The operations may further comprise sending, to the data source, the first configuration. The operations may further comprise receiving, from a second service, an indication of data analysis associated with data generated by the data source. The operations may further comprise determining, based at least in part on the indication of the data analysis and at least one of the one or more policies, a second configuration associated with the data source. The operations may further comprise sending, to the data source, the second configuration.

The system described in FIG. 4 may further comprise wherein at least one of the one or more policies comprises: an indication for the data source to generate data, an indication for the data source to stop generating data, an indication for the data source to generate a particular data feature, an indication of a data generation schedule, an indication of a rate of data generation, an indication of a volume of data generation, an indication of a condition to trigger data generation, or an indication for the data source to conduct a processing operation on generated data.

The system described in FIG. 4 may further comprise wherein the data analysis comprises at least one of: determining an importance associated with at least a portion of the data generated by the data source, determining a distribution of the data generated by the data source, or determining metadata associated with the data generated by the data source.

The system described in FIG. 4 may further comprise a plurality of data source profiles, wherein each one of the plurality of data source profiles comprises information associated with a list of one or more configurations supported by each one of the plurality of data sources.

The system described in FIG. 4 may further comprise operations comprising storing an indication of at least one of: a list of entities the data generated by the data source interacts with or a list of operations applied to the data generated by the data source.

The system described in FIG. 4 may further comprise wherein the data generated by the data source comprises at least a portion of a training dataset for a machine learning model.

The system described in FIG. 4 may further comprise wherein the second service comprises at least one of a data preparation service, a data processing service, a machine learning service, a model training service, or a feature engineering service.

The system described in FIG. 4 may further comprise wherein at least one of the first service or the second service is provided as a middleware service.

The system described in FIG. 4 may further comprise wherein the middleware service is a service layer located on top of network protocol stacks.

The system described in FIG. 4 may further comprise wherein the service layer is defined according to a telecommunications standard.

The following section elaborates examples of case-specific procedures for data source management.

In a first option, the data source management service may dynamically change the configuration of which columns of data should be generated or collected by the data sources based on data insights such as the importance of a feature (column). FIG. 5 shows an example procedure. Note that the steps may occur in a different order than the ones shown in the figure.

Step 0: In the current configuration, the data source(s) provide data comprising a certain feature-X. The feature may correspond to one or more columns in the data.

Step 1: The data source management service may receive data insights indicating that feature-X is less important (e.g., the relative importance of feature-X is lower than a threshold, feature-X is highly correlated to another feature or may be implied by another feature). Based on the Management Policy specified in the data source management service request, the data source management service may determine the required operation to be performed. For example, the policy may specify that feature-X no longer needs to be provided/collected by the data sources.

Step 2: By examining the data source profiles and data instance profiles, the data source management service may identify which data source(s) are generating data with feature-X and which column(s) of the data correspond to feature-X. The data source management service may send a message to the identified data sources requesting/instructing the data source to stop generating/collecting feature-X (or the columns of data associated only with feature-X).

Note: Data comprising feature-X might be required by different pipelines associated with more than one requestor. Being less important for one pipeline/requestor does not necessarily indicate being less important for the other pipelines/requestors. In this case, the data source management service may not instruct the data sources to stop generating/collecting feature-X. Instead, the data source management service may instruct the data sources to stop sending feature-X to the pipelines where it is less important.

The data source management service may maintain a record (e.g., using Management Operation Record in the data source profiles) of the identified data sources and the management operations that have been performed for easy roll-back, or use versioning on data source profiles.

Step 3: In order to keep receiving data insights regarding feature-X, the data source management service may request the data sources to provide feature-X occasionally/infrequently. For example, the data source may be configured such that a data instance comprising feature-X could be generated every other ten data instances. This way the dropped feature-X may get re-evaluated occasionally in case the feature regains importance at a later time.

Step 4: The data source management service may receive data insights indicating that feature-X becomes important again (for the same pipeline or for a different pipeline). Based on the management policy specified in the data source management service request, the data source management service may determine the required operation to be performed, such as to resume the collection process of feature-X.

Step 5: The data source management service may identify which data source(s) may generate/provide data with feature-X and which column(s) of the data correspond to feature-X based on the data source profiles and/or the Management Operation Record. The data source management service may send a message to the identified data sources requesting/instructing the data source to (re) start generating/collecting feature-X (or the columns of data associated with feature-X).

A similar procedure may apply to the case where a feature is less important initially and gains importance later. For example, in an initial configuration, the data source management service may instruct the data source to collect a portion of the columns in the supported data format while infrequently sampling the left-out columns (as in step 3). The data source management service may receive a data insight indicating a left-out feature/column gains importance, and the data source management service may instruct the data source to start collecting the feature/column regularly. In this method, data feature/column will be generated/collected only when the data feature/column is useful, which may help limit the size of the generated data instance and reduce the cost of the data collection process.

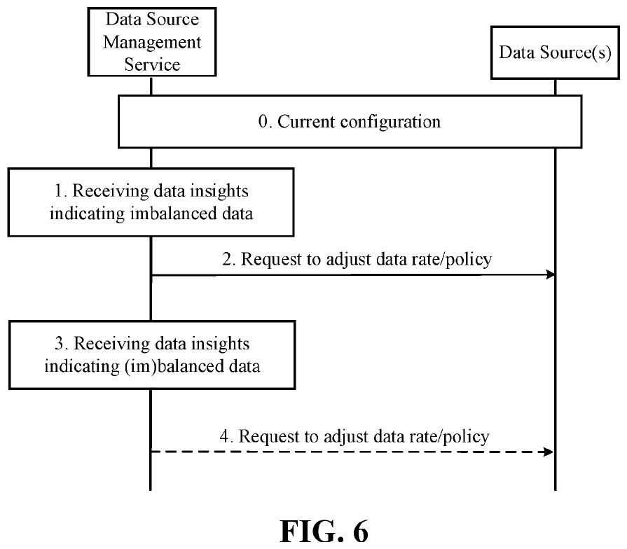

In another option, the data source management service may dynamically change the configuration of data generation/collection rate at the data sources or the volume of data provided by each data source based on data insights such as the distribution of data, detection of data imbalance, bias, and the like. FIG. 6 shows an example procedure. Note that the steps may occur in a different order than the one shown in the figure.

Step 0: The data source(s) are providing data at a certain rate that is specified in the current configuration in data source profile(s).

Step 1: The data source management service may receive data insights indicating that the data (across different classes/categories) is not balanced. For example, in a classification problem, the data samples belonging to one class are much more than the samples belonging to the other classes. Data collected at the current rate may not catch an abnormality that may occur infrequently in the system. Based on the management policy specified in the data source management service request, the data source management service may determine the required operation to be performed. For example, the policy may specify that when data imbalance is detected, the data generation rates of different classes should be adjusted so that the number of data samples belonging to different classes are roughly the same or the rate of collection should be increased to capture infrequent abnormalities.

Step 2: By examining the data source profiles and data instance profiles, the data source management service may identify which data source(s) are generating data samples that belong to the majority/overwhelming or minority/underwhelming classes. The data source management service may send a message to the identified data sources requesting/instructing the data source to reduce or increase the data generation/collection rate or the volume of data to be generated/collected.

Note: A data source may be providing data for pipelines associated with more than one requestor. This may result in different preferences of data generation/collection rates at the same data source. In this case, the data source management service may coordinate the preferences. For example, the data source management service may configure the data source to provide data at the highest desired data rate while generating a down-sampled data instance for the request/pipeline that prefers lower data rate.

Step 3 and 4: The data source management service may receive data insights indicating that the data imbalance issue has or has not been resolved with the updated configuration in step 2. If the data is balanced, the updated configuration could be kept. If the data is still not balanced, the data source management service may instruct the data sources to further reduce or increase the data rate, or determine another applicable operation (e.g., to deactivate the data source or activate a new data source).

In the data collection process, if data is collected at the data sources based on certain trigger condition, the data source management service may adjust the data collection rate by adjusting the corresponding data collection policy or condition in the data source profile. For example, a data collection process may be defined as recording data when a certain value associated with the data exceeds a threshold. In this case, the data source management service may reduce the data generation rate by configuring a higher threshold. The data source management service may gradually increase the threshold in the configuration to reduce the data generation rate. When the data source management service receives data insight indicating the data is balanced, the data source management service may stop changing the configuration and maintain the current threshold.

Besides, the data collection rate at the data sources may also be adjusted based on the data flow rate in the pipeline. For example, a data function in the pipeline may be underperforming and affecting the data flow rate in the pipeline. After receiving information indicating a reduced data flow rate in the pipeline, the data source management service may update the configuration of the corresponding active data sources to reduce the data generation/reporting rate in order to match the data flow rate in the pipeline and avoid congestion in the pipeline.

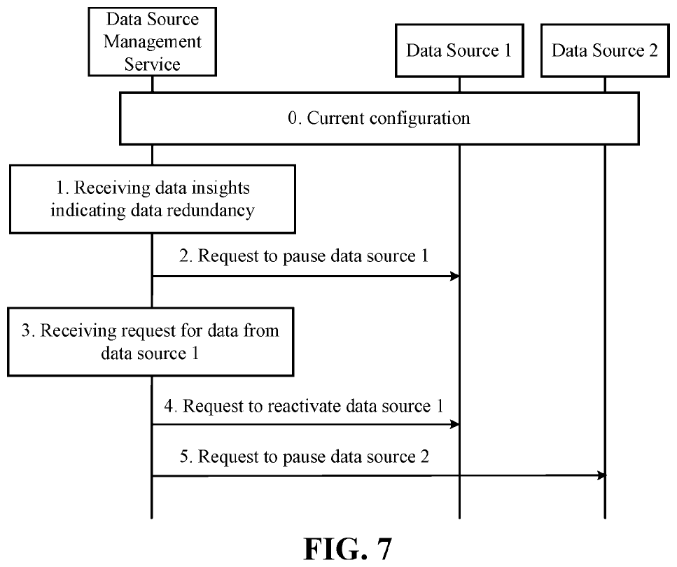

In another option, the data source management service may dynamically change the configuration of which data sources should be activated or paused/deactivated based on data insight such as the variety of data, distribution of data, bias, duplication/redundancy, and the like. FIG. 7 shows an example procedure. Note that the steps may occur in a different order than the one shown in the figure.

Step 0: In the current configuration, both Data Source 1 and Data Source 2 are selected to actively generate data, possibly for multiple data pipelines. The data sources that are not selected in the current configuration may remain in inactive/idle status.

Step 1: The data source management service may receive data insights indicating that the data lacks variety (e.g., repeated or similar data samples which cannot contribute to the training performance of a ML model). Based on the management policy specified in the data source management service request, the data source management service may determine the required operation to be performed. For example, the policy may specify that the redundant data no longer needs to be provided/collected by the data sources.

Step 2: By examining the data source profiles and data instance profiles, the data source management service may identify which data source(s) are generating the redundant data. The data source management service may send a message to the identified data sources requesting/instructing the data source to stop generating/collecting data.

For example, if the data provided by Data Source 1 and Data Source 2 reach a threshold similarity, it may be unnecessary to have both data sources generating data for a training request. The data source management service may pause/deactivate the data generation process at one of them. When determining which data source may be deactivated, the data source management service may take into consideration factors such as: whether the data source is providing data for other requests where the data is not redundant, availability or stability of the data sources, operational cost, and the like. In this case, it is assumed that Data Source 1 is not involved in any other data collection request. The data source management service may send a request to Data Source 1 to pause the data collection process.

If the data sources are managed by other management service (e.g., the data sources are devices that are managed by a device management service) and/or are not directly accessible/configurable by the data source management service, the data source management service may request the corresponding management service to perform the management operation while specifying the requirements (e.g. deactivating one of the two devices associated with the data sources). In this case, the data source management service may send a request to the corresponding device management service to deactivate one of the two devices where the decision of which device should be deactivated is left to the device management service. In this approach, the data source management service provides assistance to the device management service by translating data insights into device selection criteria that may be used by the device management service.

Deactivating a data source when the data from this source is not needed may reduce the operational cost of the data source entity and improve the efficiency.

Step 3: At a later time, the data source management service may receive a request for data originated from Data Source 1.

Step 4: The data source management service may send a request to re-activate Data Source 1 or resume the data generation/collection process at Data Source 1.

Step 5: Now that Data Source 1 is back to generate data but only one of Data Source 1 and Data Source 2 is needed (as indicated in the data insights received in step 1), the data collection process at Data Source 2 may be paused to avoid duplication/redundancy of data.

A similar procedure may apply to the case where a data source is inactive initially and activated later. For example, in an initial configuration, the data source management service may select a subset of the candidate data sources to provide the required data. When the data source management service receives data insight indicating more data is required (e.g., due to data imbalance or due to another data source becoming unavailable) and the unselected data source is able to provide the data, the data source management service may instruct the data source to start collecting the required data. In this method, the data collection process could start with a smaller set of active data sources and additional data sources will be activated only when necessary, thus improving the efficiency of the process.

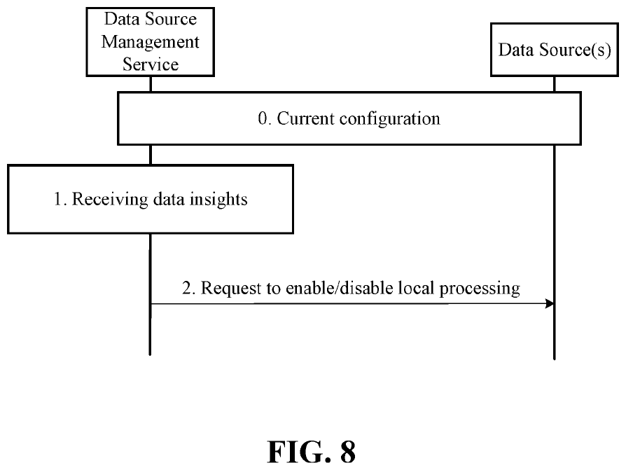

In another option, the data source management service may dynamically enable or disable local processing at the data sources such as filtering, throttling, up-sampling/down-sampling, and the like. FIG. 8 shows an example procedure.

Step 0: The data source(s) are providing data at a certain rate that is specified in the Current Configuration in data source profile(s).

Step 1: The data source management service may receive data insights indicating that a certain issue with the data has been detected. Based on the management policy specified in the data source management service request, the data source management service may determine that local processing should be enabled or disabled at one or more data sources.

Step 2: By examining the data source profiles and data instance profiles, the data source management service may identify which data source(s) should enable/disable local processing and what local processing should be applied. The data source management service may send a message to the identified data sources requesting/instructing the data source to enable/disable the identified local processing.

For example, the received data insights may indicate that data from a certain category is insufficient while the data source profiles may indicate the data sources are not able to further increase the data generation rate. In this case, the data source management service may check whether any of the data sources has local processing capability such as up-sampling or synthetic data generation. If a capable data source is found, the data source management service may instruct the data source to enable such capability.

In another example, the received data insights may indicate a certain column of data is not needed. However, some data source may not support flexible data collection and the unneeded column will be collected anyway. In this case, if the data source is capable of performing local processing of removing the unneeded column of data, the data source management service may instruct the data source to enable such capability. Data processing such as removing a column may also be done in the data pipeline. However, applying local processing may help ensure data from different sources shares the same format when entering the pipeline.

The Data Source Management service may build the required dataset by aggregating/combining data that is generated/provided from multiple data sources. The Data Source Management service may coordinate the data and/or the data collection processes from multiple data sources.

For example, the requestor may specify in the request that the required data set should consist of data from various perspectives with minimal overlap. By examining the insights associated with the data from different data sources, the data source management service may identify the overlap and adjust the configurations of the data sources to minimize the overlap (e.g., by configuring the data format of each data source, by instructing a data source to drop a column, by deactivating a data source, and the like)

Data sources may generate data in different data formats. Having data sources generate data in the same format may reduce the load or even eliminate the need of any data processing functions that could be required to process the data into the same format. The data source management service may identify the data format that may be supported by all the data sources and configure the data sources to generate data in the same format. If not all the data sources may support the same format, the data source management service may selectively activate a portion of the data sources which may support the same format, or request the data sources to enable local processing to align the data format.

Data sources may be generating or reporting data according to a certain schedule. The data source management service may configure the data sources to align or stagger their data generation/reporting schedules. For data sources that support different data generation/reporting rates, the data source management service may request all the data sources to generate/report data at the same rate, or configure the data rate to be the lowest/highest supported rate among all the active data sources, or configure the data rate at each data source individually to be able to aggregate/combine the data from different sources.

A data source may be providing data for multiple pipelines for the same or different request (or) s. In this case, the data source management service may determine whether to manage the data source in a per-pipeline basis (maintaining a separate data source profile for each pipeline). The data source management service may coordinate the data collection/generation processes for different pipelines at the same data source. For example, if different pipelines require the same format of data but in different data rate, the service may configure the data source to generate data at the maximum required data rate and perform local processing by down-sampling data to align the data with the slower rate. If different pipelines require different data from the same data source, the service may configure the data source to generate data for different pipelines at different time intervals, where the length of each interval may be determined by the required quantity of data from each pipeline (e.g., lengths of the intervals should be proportional to the requirements respectively).

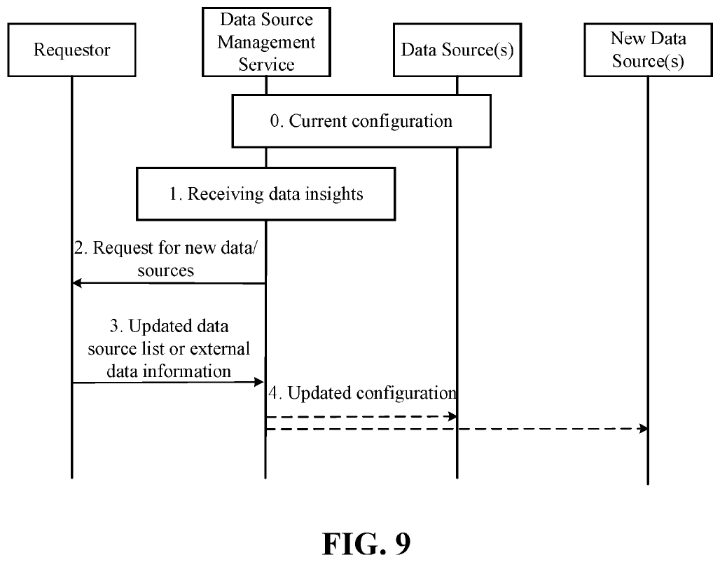

If the data insight indicates that certain data is missing (e.g., a feature of data, data from a certain category, and the like) while the missing data cannot be provided by any of the data sources provided by the requestor, the data source management service may notify the requestor and request for new data source candidates or external data/information. The data source management service may update the configurations of the data sources taking in the newly added candidates or inject the external data to the data generated by the existing data sources. FIG. 9 shows an example procedure. Note that the steps may occur in a different order than the ones shown in the figure.

Step 0: In the current configuration, the data source(s) are providing data as configured by the data source management service.

Step 1: The data source management service may receive data insights indicating that an issue is detected, e.g., a feature of data is missing, data from a certain class/category is missing, and the like. However, after examining the Management Policy and the Supported Configuration of the data sources, or after applying different data source configurations, the data source management service determines that the issue cannot be resolved by configuring the existing data sources (provided by the requestor in the request).

Step 2: The data source management service sends a message to the requestor indicating the issue with the data and requesting for new data sources or external data.

Step 3: The requestor may send an updated request to the data source management service with updated Data Source Identifiers that comprises new data source candidates. Alternatively, the requestor may send an updated request with updated Management Policy that comprises information of external data which could be injected to the data generated by the existing data sources.

Step 4: After receiving information of the updated data sources or external data, the data source management service may update the configuration of data sources accordingly.

The following figures show an example GUI for the data source management service proposed in this disclosure. A user (requestor) may use the GUI to request data source management service, provide information needed by the service, and view information (result) of the service.

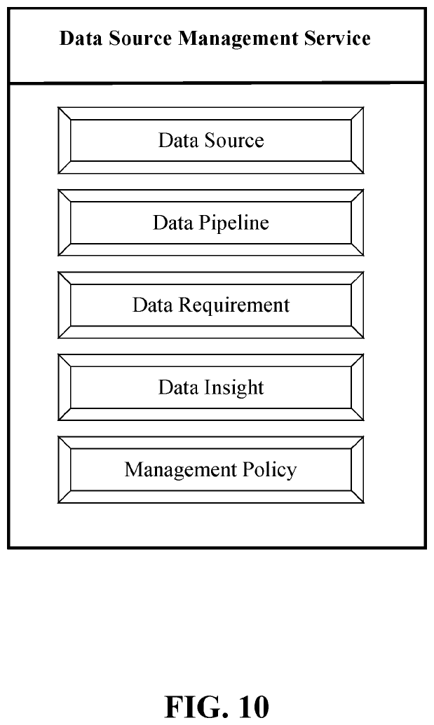

FIG. 10 shows the GUI for service overview. The user may choose different options by clicking the corresponding button to view and/or edit information regarding the data sources, the data pipeline, configure data requirements and management policies, and view the data insights associated with the data.

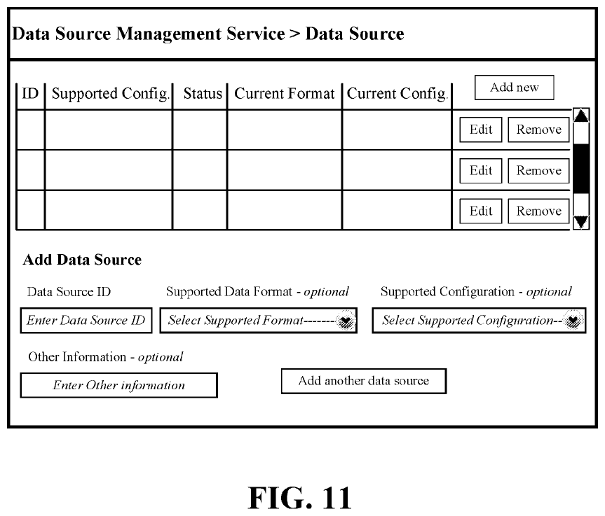

FIG. 11 shows the GUI for viewing and editing data source information. The user may provide data source information to the management service by adding data source and specifying information of the data source, which corresponds to the procedure where the requestor may specify Data Source Identifiers and Data Source Profiles in the service request. The GUI may also display information of the data sources that have been added, where the displayed information is based on the data source profiles maintained at the management service.

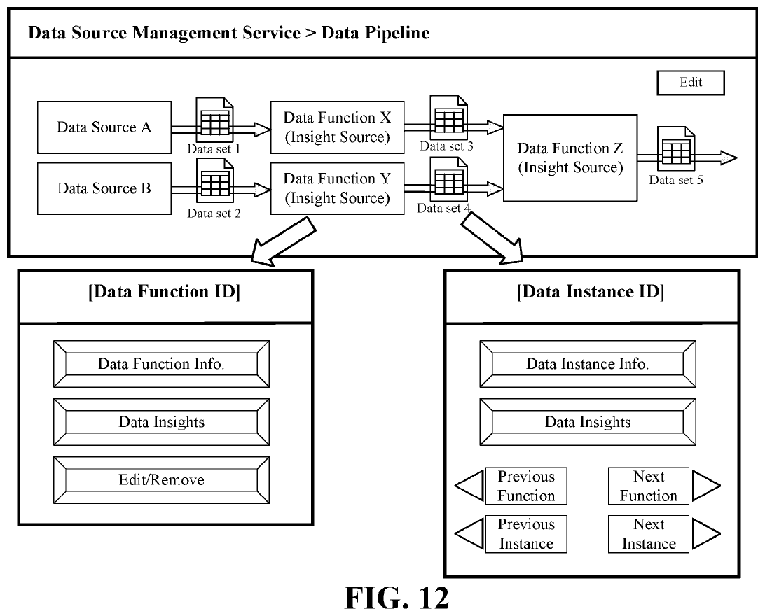

FIG. 12 shows the GUI for viewing and editing data pipeline information. The user may provide data pipeline information to the management service by adding data functions and specifying how the data should flow through the data functions, which corresponds to the procedure where the requestor may specify Pipeline Information in the service request. The user may click on a data function in the pipeline to view or edit information of the data function, as well as to view the data insights generated by the data function, if any. The user may also click on a data instance in the pipeline to view the information and insights associated with the data instance, where the displayed information is based on the data instance profiles maintained at the management service.

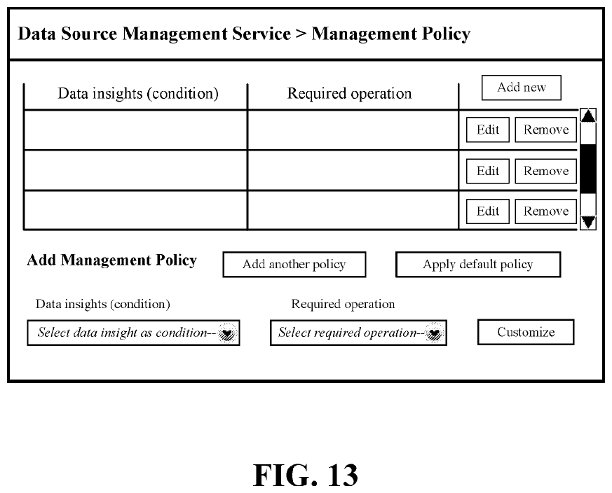

FIG. 13 shows the GUI for viewing and editing management policies. The user may add new policies by specifying the operation that should be performed when a certain data insight is generated/detected, which corresponds to the procedure where the requestor may specify Management Policy in the data source management service request. The user may choose to apply default policies, or select from options provided by the management service, or define customized policies. The GUI also allows the user to edit or remove an existing policy.

The 3rd Generation Partnership Project (3GPP) develops technical standards for cellular telecommunications network technologies, comprising radio access, the core transport network, and service capabilities-comprising work on codecs, security, and quality of service. Recent radio access technology (RAT) standards comprise WCDMA (commonly referred as 3G), LTE (commonly referred as 4G), LTE-Advanced standards, and New Radio (NR), which is also referred to as “5G”. 3GPP NR standards development is expected to continue and comprise the definition of next generation radio access technology (new RAT), which is expected to comprise the provision of new flexible radio access below 7 GHZ, and the provision of new ultra-mobile broadband radio access above 7 GHz. The flexible radio access is expected to consist of a new, non-backwards compatible radio access in new spectrum below 7 GHZ, and it is expected to comprise different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases comprise the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may comprise any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories comprise, e.g., monitoring and sensor networks, device remote controlling, bi-directional remote controlling, personal cloud computing, video streaming, wireless cloud-based office, first responder connectivity, automotive recall, disaster alerts, real-time gaming, multi-person video calls, autonomous driving, augmented reality, tactile internet, virtual reality, home automation, robotics, and aerial drones to name a few. All of these use cases and others are contemplated herein.

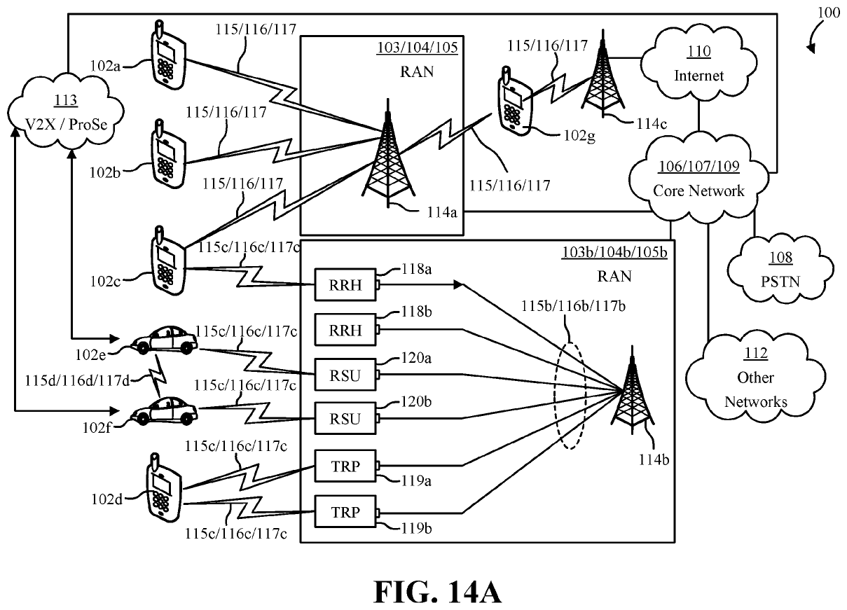

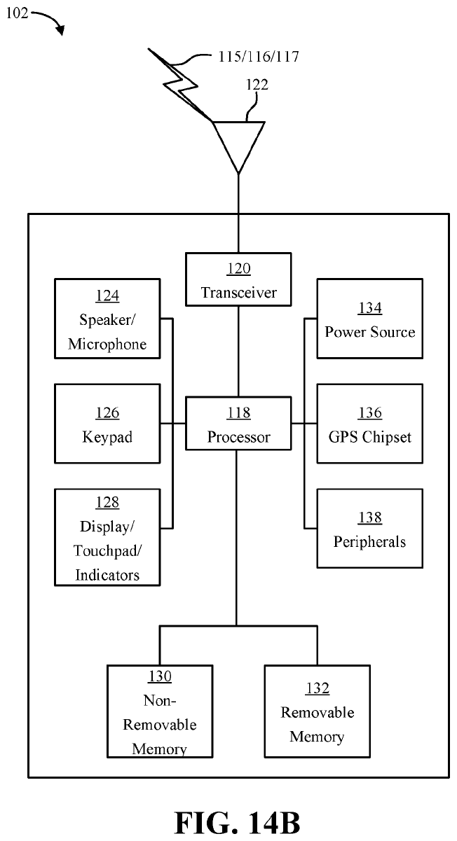

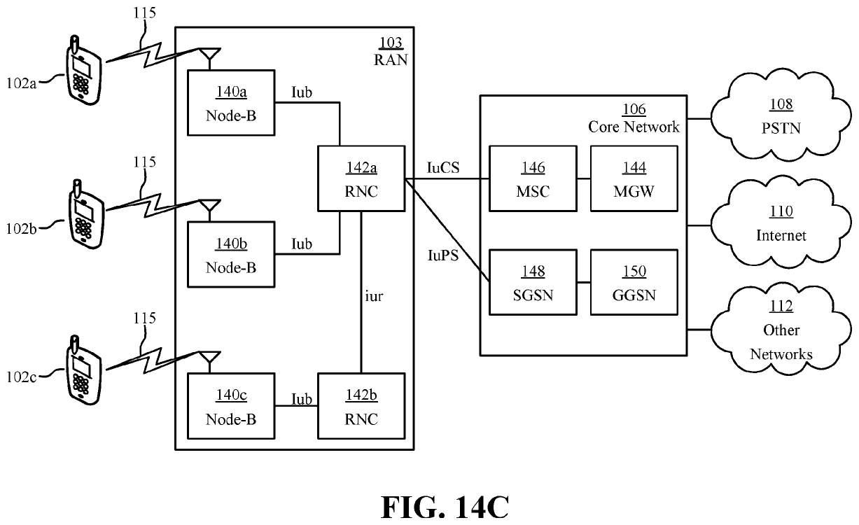

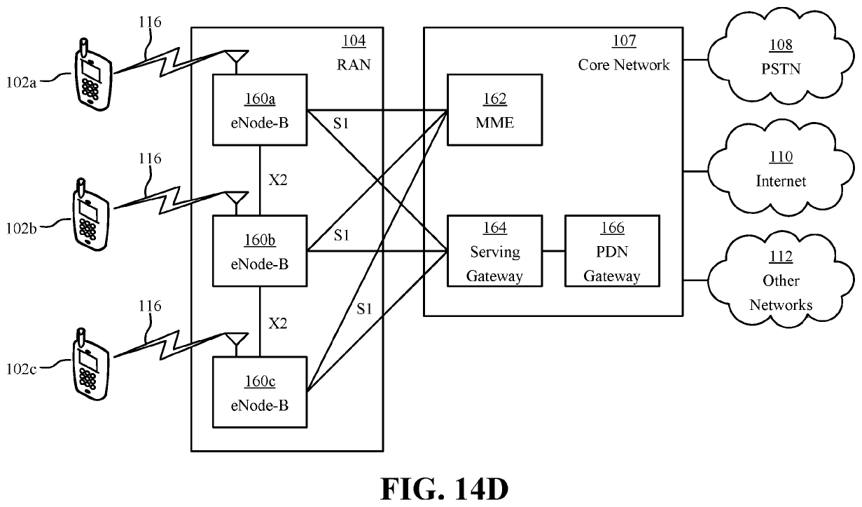

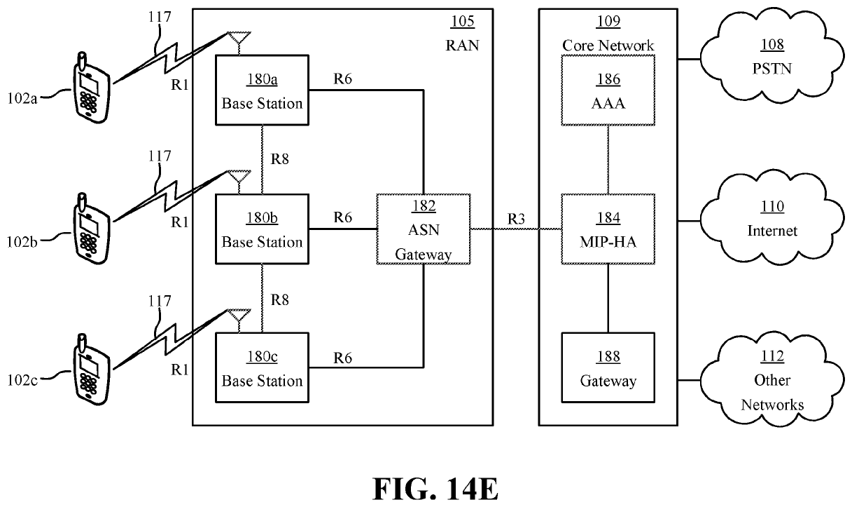

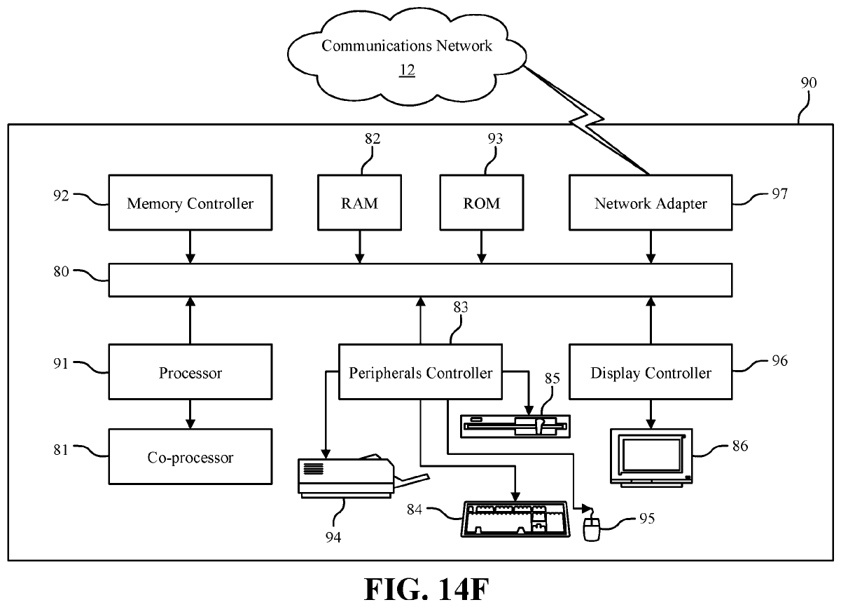

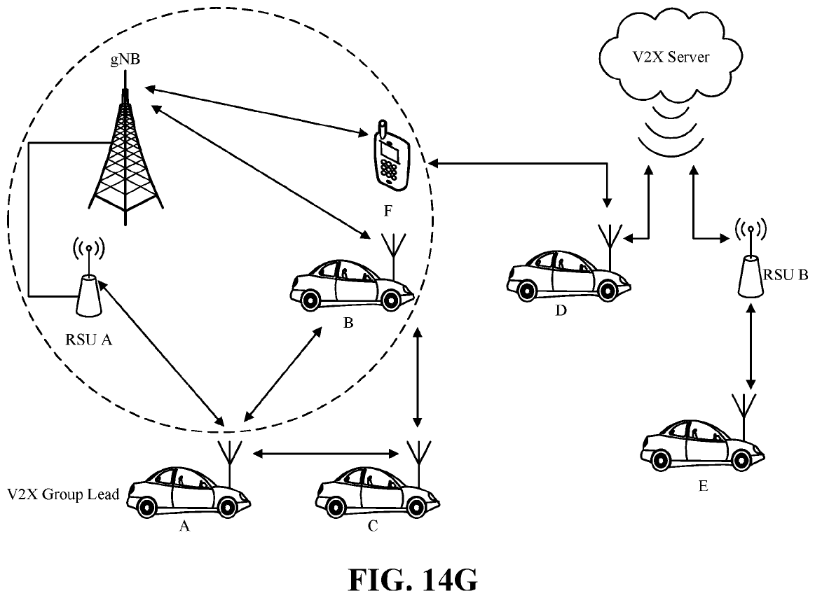

FIGS. 14A-14G show example communication systems and apparatuses in which the methods and apparatuses shown in FIGS. 1-13 may be implemented.

FIG. 14A shows an example communications system 100. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed examples contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is shown in 14A-14E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each shown as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, and the like. The base station 114b may be part of the RAN 103b/104b/105b, which may also include other base stations and/or network elements (not shown), such as a base station controller (BSC), a radio network controller (RNC), relay nodes, and the like. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, the base station 114a may include three transceivers, e.g., one for each sector of the cell. In some cases, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, and the like). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, and the like) or wireless communication link (e.g., radio frequency (RF), microwave, infrared (IR), ultraviolet (UV), visible light, cmWave, mmWave, and the like). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, and the like). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, and the like). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In some cases, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, and the like) The 3GPP NR technology includes NR V2X technologies and interface (such as Sidelink communications, and the like)

In some cases, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 14A may be a wireless router, Home Node B, Home eNode B, or access point, for example, and may utilize any suitable RAT for facilitating wireless connectivity in a localized area, such as a place of business, a home, a vehicle, a campus, and the like. In some cases, the base station 114c and the WTRUs 102e, may implement a radio technology such as IEEE 802.11 to establish a wireless local area network (WLAN). In some cases, the base station 114c and the WTRUs 102d, may implement a radio technology such as IEEE 802.15 to establish a wireless personal area network (WPAN). In some cases, the base station 114c and the WTRUs 102e, may utilize a cellular-based RAT (e.g., WCDMA, CDMA2000, GSM, LTE, LTE-A, and the like) to establish a picocell or femtocell. As shown in FIG. 14A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, and the like, and/or perform high-level security functions, such as user authentication.

Although not shown in FIG. 14A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 14A may be configured to communicate with the base station 114a, which may employ a cellular-based radio technology, and with the base station 114c, which may employ an IEEE 802 radio technology.

FIG. 14B is a block diagram of an example apparatus or device configured for wireless communications in accordance with the aspects illustrated herein, such as for example, a WTRU 102. As shown in FIG. 14B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. Also, in some cases the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements shown in FIG. 14B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 14B shows the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some cases, the transmit/receive element 122 may be an antenna configured to transmit and/or receive RF signals. In some cases, the transmit/receive element 122 may be an emitter/detector configured to transmit and/or receive IR, UV, or visible light signals, for example. In some cases, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is shown in FIG. 14B as a single element, the WTRU 102 may include any number of transmit/receive elements 122. More specifically, the WTRU 102 may employ MIMO technology. Thus, in some cases, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example. J

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In some cases, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an aspect.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 14C is a system diagram of the RAN 103 and the core network 106. As noted above, the RAN 103 may employ a UTRA radio technology to communicate with the WTRUs 102a, 102b, and 102c over the air interface 115. The RAN 103 may also be in communication with the core network 106. As shown in FIG. 14C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an aspect of the disclosure.

As shown in FIG. 14C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 14C may include a media gateway (MGW) 144, a mobile switching center (MSC) 146, a serving GPRS support node (SGSN) 148, and/or a gateway GPRS support node (GGSN) 150. While each of the foregoing elements are shown as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 14D is a system diagram of the RAN 104 and the core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an aspect of the disclosure. The eNode-Bs 160a, 160b, 160c may each include one or more transceivers for communicating with the WTRUs 102a, 102b, 102c over the air interface 116. In some cases, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 14D, the eNode-Bs 160a, 160b, 160c may communicate with one another over an X2 interface.

The core network 107 shown in FIG. 14D may include a mobility management gateway (MME) 162, a serving gateway 164, and a packet data network (PDN) gateway 166. While each of the foregoing elements are shown as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 14E is a system diagram of the RAN 105 and the core network 109. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 14E, the RAN 105 may include base stations 180a, 180b, 180c, and an ASN gateway 182, though it will be appreciated that the RAN 105 may include any number of base stations and ASN gateways while remaining consistent with an aspect of the disclosure. The base stations 180a, 180b, 180c may each be associated with a particular cell in the RAN 105 and may include one or more transceivers for communicating with the WTRUs 102a, 102b, 102c over the air interface 117. In some cases, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 14E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are shown as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 14E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 14A, 14C, 14D, and 14E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 14A, 14B, 14C, 14D, and 14E are provided by way of example only, and it is understood that the subject matter disclosed and claimed herein may be embodied or implemented in any similar communication system, whether presently defined or defined in the future.

FIG. 14F is a block diagram of an exemplary computing system 90 in which one or more apparatuses of the communications networks illustrated in FIGS. 14A, 14C, 14D and 14E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 14A, 14B, 14C, 14D, and 14E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 14G shows an example communications system 111 in which the methods and apparatuses described and claimed herein may be an aspect of. As shown, the example communications system 111 may include wireless transmit/receive units (WTRUs) A, B, C, D, E, F, a base station, a V2X server, and a RSUs A and B, though it will be appreciated that the disclosure contemplates any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

What is claimed is:

1. A method performed by a first service entity for a service supporting service capabilities through a set of application programming interfaces (APIs) in a network, the method comprising:
receiving a first request to configure a data source of a plurality of data sources, wherein the first request comprises one or more policies for configuring the data source to generate data;
determining, based on at least one of the one or more policies, a first configuration associated with the data source;
sending, to the data source, the first configuration;
receiving, from a second service entity, an indication of data analysis associated with data generated by the data source;
determining, based at least in part on the indication of the data analysis and at least one of the one or more policies, a second configuration associated with the data source; and
sending, to the data source, the second configuration.

2. The method of claim 1, wherein at least one of the one or more policies comprises: an indication for the data source to generate data, an indication for the data source to stop generating data, an indication for the data source to generate a particular data feature, an indication of a data generation schedule, an indication of a rate of data generation, an indication of a volume of data generation, an indication of a condition to trigger data generation, or an indication for the data source to conduct a processing operation on generated data.

3. The method of claim 1, wherein the data analysis comprises at least one of: determining an importance associated with at least a portion of the data generated by the data source, determining a distribution of the data generated by the data source, or determining metadata associated with the data generated by the data source.

4. The method of claim 1, further comprising a plurality of data source profiles, wherein each one of the plurality of data source profiles comprises information associated with a list of one or more configurations supported by each one of the plurality of data sources.

5. The method of claim 1, further comprising storing an indication of at least one of: a list of entities the data generated by the data source interacts with or a list of operations applied to the data generated by the data source.

6. The method of claim 1, wherein the data generated by the data source comprises at least a portion of a training dataset for a machine learning model.

7. The method of claim 1, wherein the second service entity comprises at least one of a data preparation service, a data processing service, a machine learning service, a model training service, or a feature engineering service.

8. The method of claim 1, wherein at least one of the first service entity or the second service entity is provided as a middleware service

9. The method of claim 8, wherein the middleware service is a service layer located on top of network protocol stacks.

10. The method of claim 9, wherein the service layer is defined according to a telecommunications standard.

11. An apparatus comprising a processor and a memory, the apparatus further comprising computer-executable instructions stored in the memory of the apparatus which, when executed by the processor of the apparatus, cause the apparatus to perform, at a first service supporting service capabilities through a set of application programming interfaces (APIs) in a network, operations comprising:
receiving a first request to configure a data source of a plurality of data sources, wherein the first request comprises one or more policies for configuring the data source to generate data;
determining, based on at least one of the one or more policies a first configuration associated with the data source;
sending, to the data source, the first configuration;
receiving, from a second service, an indication of data analysis associated with data generated by the data source;
determining, based at least in part on the indication of the data analysis and at least one of the one or more policies, a second configuration associated with the data source; and
sending, to the data source, the second configuration.

12. The apparatus of claim 11, wherein at least one of the one or more policies comprises: an indication for the data source to generate data, an indication for the data source to stop generating data, an indication for the data source to generate a particular data feature, an indication of a data generation schedule, an indication of a rate of data generation, an indication of a volume of data generation, an indication of a condition to trigger data generation, or an indication for the data source to conduct a processing operation on generated data.

13. The apparatus of claim 11, wherein the data analysis comprises at least one of: determining an importance associated with at least a portion of the data generated by the data source, determining a distribution of the data generated by the data source, or determining metadata associated with the data generated by the data source.

14. The apparatus of claim 11, further comprising a plurality of data source profiles, wherein each one of the plurality of data source profiles comprises information associated with a list of one or more configurations supported by each one of the plurality of data sources.

15. The apparatus of claim 11, wherein the instructions, when executed, further cause operations comprising storing an indication of at least one of: a list of entities the data generated by the data source interacts with or a list of operations applied to the data generated by the data source.

16. The apparatus of claim 11, wherein the data generated by the data source comprises at least a portion of a training dataset for a machine learning model.

17. The apparatus of claim 11, wherein the second service comprises at least one of a data preparation service, a data processing service, a machine learning service, a model training service, or a feature engineering service.

18. The apparatus of claim 11, wherein at least one of the first service or the second service is provided as a middleware service.

19. The apparatus of claim 18, wherein the middleware service is a service layer located on top of network protocol stacks.

20. The apparatus of claim 19, wherein the service layer is defined according to a telecommunications standard.
